(19) United States
(12) Patent Application Publication
(10) Pub. No.: US 2010/0324797 A1
(43) Pub. Date: Dec. 23, 2010

(54) Method and Apparatus for Longitudinal and Lateral Guiding Assistance of Driver of a Vehicle

(75) Inventor: Hans Fritz, Ebersbach (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 12/866,673

(22) PCT Filed: Jan. 15, 2009
(86) PCT No.: PCT/EP2009/000186

§ 371 Date: Aug. 6, 2010

(30) Foreign Application Priority Data
Feb. 8, 2008 (DE) 10 2008 008 172.8

(51) Int. Cl. B60W 30/16

(52) U.S. Cl. 701/96; 701/1

(57) ABSTRACT

In a method and apparatus for the longitudinal and lateral guidance assistance to the driver of a vehicle, longitudinal guidance assistance is performed as distance regulation for regulating the distance between the vehicle and a preceding guide vehicle. Lateral guidance assistance is optionally carried out as an object tracking regulation for guiding the vehicle according to a displacement lane of a preceding guide vehicle, as a lane tracking regulation for guiding the vehicle along a marked driving lane, or as combined lane object tracking regulation. The lateral guidance assistance is then available only when the distance regulation is active and when the distance between the vehicle and the guide vehicle is smaller than a predefined distance limit and/or when a shaft angle as a viewing angle from the vehicle to the guide vehicle is smaller than a predefined angle limit.

This application is a national stage of PCT International Application No. PCT/EP2009/000186, filed Jan. 15, 2009, which claims priority under 35 U.S.C. §119 to German Patent Application No. 10 2008 008 172.8, filed Feb. 8, 2008, the entire disclosure of which is herein expressly incorporated by reference.

### BACKGROUND AND SUMMARY OF THE INVENTION

The invention relates to a method for longitudinal and lateral guidance assistance of the driver of a vehicle, and to a driver assistance system for carrying out the method.

German patent document DE 100 17 279 A1 discloses a generic method, in which the driver of the vehicle is relieved by the system taking over completely the lateral and longitudinal guidance of the vehicle with typical low driving speed region for a stop and go operation. The lateral guidance of the vehicle can thereby take place according to traffic lane markings that are applied to the driving surface and are recognized by means of a video camera; or it can take place according to a guide vehicle preceding the vehicle.

It is disadvantageous in such systems, however, that the availability of such assistance offered to the driver is restricted to the typical driving speed region for stop and go operation (indeed, a lower portion of this speed region), because the driver assistance system is deactivated as soon as the initially recognized traffic lane markings are not recognized anymore. Situations in which the traffic lane markings are no longer recognized, however often occur precisely in stop and go operation, as traffic lane markings are often obscured by preceding vehicles with the low vehicle intermediate distances speeds usual for this operation.

German patent document DE 199 19 644 C2 discloses a driver assistance system for assisting the driver in lateral guidance of a vehicle, in which a vehicle preceding the vehicle is detected as a guide vehicle. The distance to the guide vehicle and its direction angle relative to the longitudinal axis of the vehicle or the lateral distance between the vehicle and the guide vehicle are determined. The latter information is then used to generate a steering actuating signal, by which the steering angle of the vehicle is varied in such a manner that the vehicle tracks the guide vehicle as precisely as possible in its path. The assistance thus takes place in the sense of an object tracking regulation, in which the vehicle tracks the lateral displacement of the guide vehicle. This type of vehicle guide is also called shaft regulation, as the vehicle follows the guide vehicle as if it would be connected thereto via a fictitious shaft. It is disadvantageous, however, that in this system oscillating movements of the preceding guide vehicle are transferred to the vehicle. These oscillating movements are perceived to be uncomfortable and occur particularly often in traffic jam situations if the driver of the preceding guide vehicle repeatedly changes to the left or right in order to have an overview of the traffic jam situation.

One object of the present invention, therefore, is to provide a method that offers the driver a reliable assistance with a high availability and high acceptance and a relief by a assistance with a high automation degree.

Another object of the invention is to provide a driver assistance system for carrying out the method according to the invention.

These and other objects and advantages are achieved by the method for the longitudinal and lateral guiding assistance of a driver of a vehicle according to the invention, in which the longitudinal guiding assistance is performed as a distance regulation for regulating the distance between the vehicle and a preceding guide vehicle, while the lateral guiding assistance is optionally carried out as a tracking assistance for guiding the vehicle along a marked traffic lane or as a combined object tracking assistance for guiding the vehicle according to a displacement lane of the preceding guide vehicle. The lateral guiding assistance is available only under predefined operating conditions (that is, as a supporting measure), the predefined operating conditions including the conditions that the distance regulation is active, that the distance between the vehicle and the guide vehicle is lower than a predefined distance limit, and/or that a viewing angle referred to as a shaft angle from the vehicle to the guide vehicle is smaller in its amount that a predefined angle limit.

The lateral guiding assistance can take place with a high or a low degree of automation. A low automation degree means that the driver still has to observe his steering assignment in large measure, and that he is relieved only to a low measure by the lateral guiding assistance. A high automation degree means however that the steering assignment is essentially taken over by the system, so that the driver does not have to steer at all, or at least only to a small degree, and is thus relieved to a greater extent than with a low automation degree. A lane tracking assistance or object tracking assistance is thus also meant to be a lane tracking regulation or object tracking regulation as a special case of the lateral guiding assistance in the following, if this is to be carried out with a high automation degree.

An object tracking assistance is meant to be a pure object tracking assistance in the following, which is carried out only on the basis of the preceding vehicle. A lane tracking assistance is however meant to be a pure lane tracking assistance, which is carried out only on the basis of the marked traffic lane, and also the combined lane object assistance, in which the pure lane tracking assistance and the pure lane assistance are merged.

The lateral guiding assistance is preferably deactivated if the distance between the vehicle and the guide vehicle increases to a value which is larger than the predefined distance limit or if the shaft angle exceeds the predefined angle limit in its amount.

The condition for providing the lateral assistance is thus that, within a near region in front of the vehicle defined by the predefined distance limit or the predefined angle limit, a preceding vehicle suitable for a distance regulation is recognized as a guide vehicle and that the vehicle follows the preceding vehicle in a distance-regulated manner. If this condition is not fulfilled (or no longer fulfilled), the lateral assistance is not (or is no longer) offered.

The lateral guiding assistance is always carried out as a lane tracking assistance or as a combined lane object tracking assistance if traffic lane markings are detected. Oscillating movements of the guide vehicle therefore do not affect (or affect only insignificantly) the lateral guiding, as long as traffic lane markings are present and are recognized.

A switchover from lane tracking assistance or combined lane object tracking assistance is preferably carried out for the object tracking assistance if traffic lane markings are not detected any longer. The lateral guiding assistance is thereby also available with a change from a state in which the traffic lane markings are recognized, into a state in which the traffic lane markings are no longer recognized. Oscillating movements of the guide vehicle can then however effect the lateral guiding of the vehicle as interference, but this interference is accepted in favor of a higher availability.

The lateral guiding assistance is preferably only carried out as object tracking assistance if traffic lane markings are not sensed. Interference due to oscillating movements of the guide vehicle affect only the lateral guiding if traffic lane markings are not recognized.

Preferably, one switches over automatically from the object tracking assistance to the lane tracking assistance or the combined lane object tracking assistance, if traffic lane markings are detected for the first time or anew. Short-term interruptions of the traffic lane markings or interference when recognizing the traffic lane markings thereby affect the lateral guiding at the most in a small measure, which can hardly be noticed by the driver.

In an advantageous further development of the method, objects are detected with an active lane tracking assistance, which the guide vehicle passes laterally and which restrict a driving region that can be used by the vehicle in the traffic lane; and lane tracking assistance is deactivated when it is determined that the width of the driving region minus a predefined lateral safety distance that can be used is lower than the width of the vehicle.

In a further advantageous development of the method, objects are detected with an active object tracking assistance, which objects are passed laterally by the guide vehicle; and the object tracking assistance is deactivated when it is determined that a sufficient free space is not available for the vehicle to pass the objects while maintaining predefined safety distances.

When deactivating the lateral guiding assistance, a request for taking over the lateral guiding is preferably given out to the driver of the vehicle.

The invention also includes a driver assistance system for carrying out the method described above. It includes a radar-based and/or video-based object detection unit for providing object data regarding objects in the front and lateral environment of the vehicle, a video-based traffic lane recognition system for providing tracking data regarding the course of a marked traffic lane driven on by the vehicle and a control device for generating actuating signals for controlling the longitudinal and lateral displacement of the vehicle based on the provided object data and lane data.

Other objects, advantages and novel features of the present invention will become apparent from the following detailed description of the invention when considered in conjunction with the accompanying drawings.

### BRIEF DESCRIPTION OF THE DRAWINGS

FIG. 1 is a simplified block diagram of a vehicle driver assistance system for carrying out the method according to the invention;

FIG. 2 is a schematic depiction of a traffic situation to be handled by the driver assistance system according to FIG. 1, on a road with traffic lane markings that limit the lane; and

FIG. 3 is a schematic depiction of a traffic situation to be handled by the driver assistance system according to FIG. 1, on a road without traffic lane markings.

### DETAILED DESCRIPTION OF THE DRAWINGS

Parts corresponding to each other are provided with the same reference numerals in all figures.

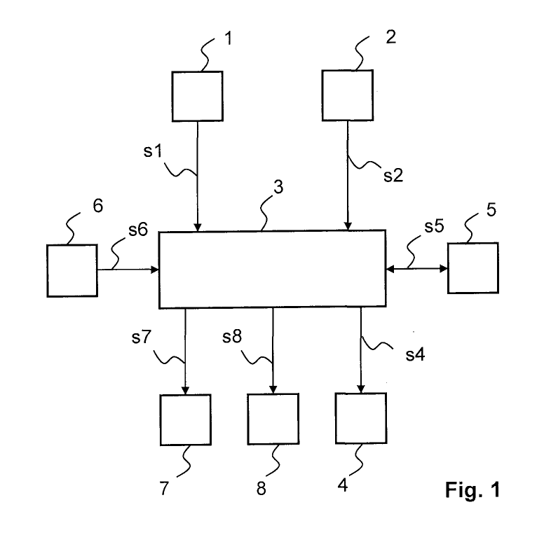

The driver assistance system shown in FIG. 1 comprises a traffic lane recognition system 1, an object recognition system 2, a control device 3, a steering actuating device 4, a human-machine interface 5, a sensor device 6, an engine torque actuating device 7 and a braking torque actuating device 8.

The traffic lane recognition system 1 operates in a video-based manner and recognizes by means of traffic lane markings, which are applied to the driving surface driven on by the vehicle as traffic lane limitations, the traffic lane course of the presently traffic lane being driven on and generates lane data s1, which represent the position of the vehicle relative to the traffic lane and the course of the traffic lane, and outputs these lane data s1 to the control device 3. Alternatively or additionally, the course of the traffic lane and the position of the vehicle relative to the traffic lane can also be determined with the help of magnetic nails, which are introduced into the driving surface and which are detected from the vehicle, or with the help of a satellite-supported position determination system by means of digital map data or by recognizing constructional limitations (e.g., curbs or curbstones).

The object detecting unit 2 detects the front and lateral environment of the vehicle with a radar or laser beam, in order to recognize objects in front of the vehicle and to determine their position relative to the vehicle and outputs corresponding object data s2 to the control device 3. It is of course conceivable to also carry out the object detection in a video-based manner with the traffic lane recognition system 1. Furthermore, there is the possibility to determine the object data by a vehicle-vehicle communication, for example based on position data of a vehicle preceding the vehicle, which are determined from this sent out via radio communication.

The sensor device 6 detects the current driving state of the vehicle, including its driving speed and supplies corresponding status data s6 to the control device 3.

The control device 3 is set up to fulfill a lateral guiding assistance function and a longitudinal guiding assistance function.

The longitudinal guiding assistance function includes regulation of the distance between the vehicle and a sensed preceding guide vehicle to a nominal distance depending on the driving speed of the vehicle, and regulation of the driving speed of the vehicle to a desired speed that can be predefined by the driver. The distance regulation is thereby active if the speed regulation would result in a shortfall of the nominal distance, and the speed regulation is active if no guide vehicle has been detected or if the distance regulation would result in exceeding the desired speed with a detected guide vehicle. These regulations are sufficiently known under the name distance regulation speed control or ACC (Automatic Cruise Control).

The lateral guiding assistance function with a high automation degree includes lane tracking assistance by lane regulation, which assists the driver when guiding the vehicle along a traffic lane marked by traffic lane markings, and object tracking assistance which assists the driver when tracking the vehicle along a displacement lane of the guide vehicle corresponding to the above-mentioned shaft regulation. The lateral guiding assistance is thereby optionally carried out either as a lane tracking assistance or combined lane/object tracking assistance. A switchover between these two types of assistance advantageously takes place in such a manner that the effect of one type of assistance is gradually increased and the effect of the other type of assistance is reduced to such a measure as this increase takes place, so that a gradual transition from one type of assistance to the other type of assistance takes place and both types of assistance are effective in the transition region.

The control device 3 controls a steering adjusting device 4 for fulfilling the lateral guiding assistance function. This varies in dependence on a steering adjusting signal output as a steering instruction, for adjusting the steering angle to the steerable wheels of the vehicle and thus effects a lateral guiding of the vehicle assisting the driver. The steering adjusting signal s4 thereby corresponds to an additional steering torque and/or an additional steering angle, which is superposed in an additive manner by a steering torque or steering angle predefined by a steering wheel actuation from the driver. The steering adjusting device 4 is preferably designed as a steering torque adjuster, so that a haptic feedback is given to the driver in a first escalation step at the steering wheel, whereby he is advised to take on the steering object. The steering instruction can effect a haptic feedback in the form of a vibration on the steering wheel in addition to the additional steering torque.

In order to fulfill the distance regulation function, the control device 3 controls the engine torque actuating device 7 and the braking torque actuating device 8 via an engine torque actuating signal s7 and a braking torque actuating signal s8, in order to regulate the distance to the recognized preceding vehicle by varying the drive and/or braking torque.

The human-machine interface 5 gives the driver the possibility to choose if the longitudinal guiding assistance and the lateral guiding assistance shall be offered to him as assistance measures, and also informs the driver about operating states of the driver assistance system. The human-machine interface 5 communicates with the control device 3 via interface data s5 for this.

The human-machine interface 5 has input means (not shown) for activating the longitudinal guiding assistance function. The input means can in particular be designed as a multi-function operating lever, which has to be deflected into a certain direction for activating the longitudinal guiding assistance function. If the distance regulation function regulates the distance to the guide vehicle also in the low speed region until standstill, it is advisable to interrupt the distance regulation function after a standstill, and to activate it again only after a renewed activation on the part of the driver, actuating the multi function lever, or actuating the drive pedal of the vehicle. The drive pedal thus also functions as an input means for activating the longitudinal guiding assistance function, if the latter was interrupted due to a standstill.

The human-machine interface 5 further has a display unit (not shown) via which the driver is informed about the current operating state of the driver assistance system. If the conditions for carrying out the assistance are not fulfilled anymore, the driver is requested via the display device to take over completely the vehicle guiding.

The control device 3 is set up in such a manner that the lateral guiding assistance with a high automation degree is offered as an assistance measure only if predefined operating conditions are fulfilled, and is deactivated after an activation, as soon as the predefined conditions are no longer fulfilled. The predefined conditions comprise at least that distance regulation is active (that is, that a guide vehicle has been detected and that a distance-regulating intervention with regard to the detected guide vehicle is temporarily carried out), and that the guide vehicle is within a predefined near region in front of the vehicle (that is, the distance between the vehicle and the guide vehicle is smaller than a predefined distance limit and that a viewing angle referred to as shaft angle from the vehicle to the guide vehicle is smaller than a predefined angle limit). The lateral guiding assistance with a high automation degree is accordingly deactivated as soon as the guide vehicle initially in the near region leaves the near region towards the front or the side, or as soon as the distance regulation is not active anymore, which is for example the case if the operating mode of the longitudinal guiding assistance function is switched over from the distance regulation to the speed regulation.

The lateral guiding assistance with a high automation degree is principally carried out as a lane tracking assistance or combined lane object tracking assistance, if traffic lane markings are detected, and it is carried out as a pure object tracking assistance only as an exception, if traffic lane markings are not detected.

When changing from a state in which traffic lane markings are detected into a state in which traffic lane markings are not detected anymore, an automatic switchover from the lane tracking assistance or combined lane object tracking assistance to the pure object tracking assistance takes place. If the traffic lane markings are subsequently again detected, one switches automatically from the object tracking assistance back into the lane tracking assistance or combined lane object tracking assistance.

With the lateral guiding assistance, additional objects are considered, which the vehicle has to pass laterally when following the guide vehicle. If these objects restricting the usable driving region are recognized, and if it is further determined that free space next to the objects is not sufficient to guide the vehicle past the respective object with a predefined lateral safety distance to the respective object and to the traffic lane markings which are possibly present, the lateral guiding assistance and preferably also the longitudinal guiding assistance is deactivated, and a take-over request is made of the driver with the aim to inform the driver that the lateral guiding assistance is no longer available, and to invite him to take up the lateral guiding. Thereby, the responsibility regarding the vehicle guidance is completely transferred to the driver in critical situations that cannot be handled safely by the driver assistance system.

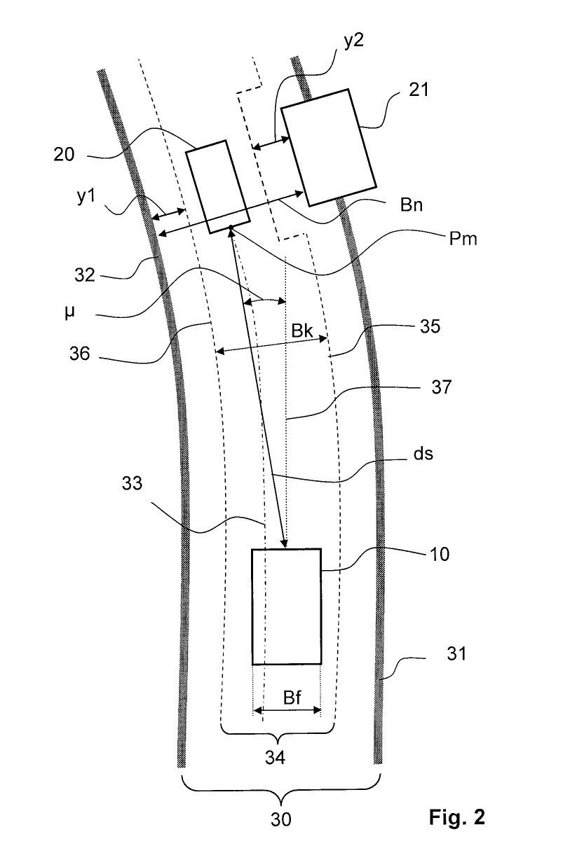

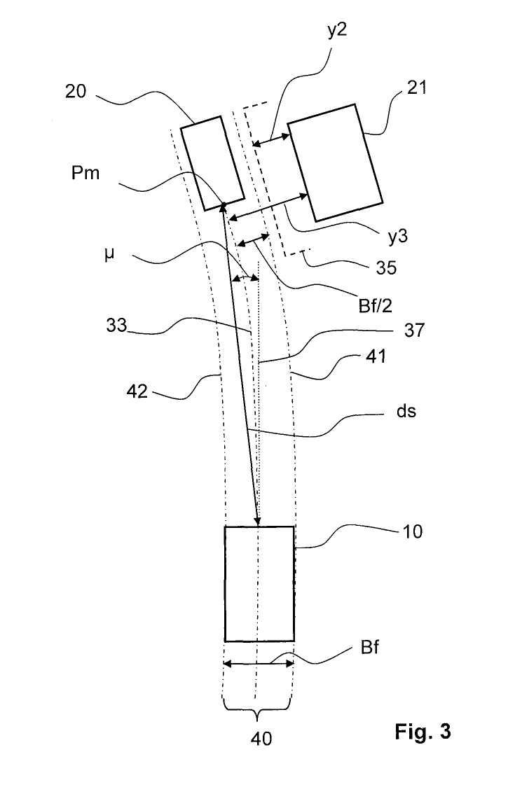

The details of such a consideration of objects are described in the following by means of FIGS. 2 and 3.

FIG. 2 shows a road with a traffic lane 30 limited by traffic lane markings 31, 32, in which a vehicle 10 equipped with the driver assistance system according to FIG. 1 follows a guide vehicle 20 preceding with a nominal distance in the same traffic lane 30. The guide vehicle 20 passes an object 21 projecting into the traffic lane 30. A point Pm marks a lateral center point at the guide vehicle, for example at the rear of the guide vehicle 20. A dash-dotted line 33 marks the displacement lane of the guide vehicle 20, that is, the plot of the lateral center point Pm. The lines 35 and 36 mark limits, which are to be maintained as lateral safety distance y1, y2 to the traffic lane markings 31, 32 or the object restricting the usable driving region. The lateral safety distances y1, y2 to the traffic lane markings or to the objects can be chosen differently. In particular, the lateral safety distance y1 to be maintained to the traffic lane marking 31, 32 can be smaller than the lateral safety distance y2 to be maintained to the object 21. A dotted line 37 marks the longitudinal axis of the vehicle 10 and the double arrow μ marks the angle designated as shaft angle between the longitudinal axis 37 of the vehicle 10 and the line of sight from the vehicle 20 to the lateral center Pm of the guide vehicle 20 (that is, the line of sight from the vehicle 10 to the guide vehicle 20). The double arrow Bn designates the width of the usable driving region between the object 21 and the traffic lane marking 32 opposite thereto. A further double arrow Bf marks the width of the vehicle 10.

In the present case, the predefined operating conditions for the lateral guiding assistance are fulfilled, that is, the vehicle 10 follows the guide vehicle 20 in a distance-regulated manner and the guide vehicle 20 is still in the predefined close region of the vehicle 10 (that is, within the predefined distance limit and within the predefined angle limit). The lateral guiding assistance takes place due to the present and detected traffic lane markings 31, 32 as lane tracking assistance or combined lane object tracking assistance. As soon as it is determined that the width Bn of the usable driving region minus a predefined left and right lateral safety distance (y1, y2) is smaller than the width (Bf) of the vehicle 10, the lateral guiding assistance is deactivated. That is, the deactivation takes place if the condition Bf<Bn−(y1+y2) is fulfilled. The driver is requested temporally before the deactivation by the output of a corresponding take-over request for taking over the lateral guiding.

FIG. 3 shows the same situation for the case that no traffic lane markings are present on the road. In this case, the lateral guiding assistance is carried out as a pure object tracking assistance. The lines 41, 42 thereby mark the limits of a path 40, in which the vehicle 10 is tracked behind the guide vehicle 20. The double arrow y3 marks the lateral distance of the displacement lane 33 to the object 21. If this lateral distance y3 is smaller than the lateral safety distance y2 to be maintained to the object plus half the width Bf/2 of the vehicle 10 (that is, if the path 40 is not at least spaced by the lateral safety distance y2 from the object 21), the object tracking assistance is deactivated with a request to the driver to take on the transverse guiding.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-10. (canceled)

11. A method for the longitudinal and lateral guidance assistance for a driver of a vehicle, wherein:
longitudinal guiding assistance is performed as a distance assistance for regulating the distance between the vehicle and a preceding guide vehicle;
lateral guiding assistance may be carried out as one of an object tracking assistance for guiding the vehicle according to a displacement lane of the preceding guide vehicle, a lane tracking assistance for guiding the vehicle along a marked traffic lane and combined lane and object tracking assistance;
lateral guiding assistance is available only when predefined operating conditions are fulfilled;
the predefined operating conditions comprise the condition that the distance regulation is active;
the predefined conditions further comprise at least one other condition selected fro the group consisting of i) that the distance between the vehicle and the guide vehicle is smaller than a predefined distance threshold, and ii) that a shaft angle as a viewing angle from the vehicle to the guide vehicle is smaller in its amount than a predefined angle limit.

12. The method according to claim 11, wherein the lateral guiding assistance is always carried out as one of a lane tracking assistance and a combined lane object tracking assistance, when traffic lane markings are detected.

13. The method according to claim 12, wherein a switchover from the lane tracking assistance or combined lane object tracking assistance takes place for the object tracking assistance, if traffic lane markings are no longer detected.

14. The method according to claim 11, wherein the lateral guiding assistance is carried out as an object tracking assistance only if traffic lane markings are not detected.

15. The method according to claim 14, wherein a switchover from the object tracking assistance to one of lane tracking assistance and combined lane object tracking assistance takes place when traffic lane markings are detected for the first time or are detected again.

16. The method according to claim 11, wherein:
objects that the guide vehicle passes laterally, and which restrict a driving region that can be used by the vehicle in the traffic lane, are detected with an active lane tracking assistance or combined lane object tracking assistance; and
the lane tracking assistance or the combined lane/object tracking assistance is deactivated when the width of the usable driving region minus a predefined left and right lateral safety distance is smaller than the width of the vehicle.

17. The method according to claim 11, wherein:
objects which the guide vehicle passes laterally are detected with an active object tracking assistance; and
object tracking assistance is deactivated, if there is insufficient free space for the vehicle to pass the objects, while maintaining predefined safety side distances.

18. The method according to claim 11, wherein lateral guidance assistance is deactivated if the distance between the vehicle and the guide vehicle increases to a value that is larger than the predefined distance threshold.

19. The method according to claim 18, wherein, when lateral guidance assistance is deactivated, a request is output to the driver of the vehicle to take over lateral guidance.

20. A driver assistance system for a vehicle comprises:
a video-based traffic lane recognition system for providing lane data with regard to the course of a marked traffic lane driven on by a vehicle with a radar-based and/or video-based object detection unit for providing object data with regard to objects in the front environment of the vehicle; and
a control device for generating actuating signals for controlling the longitudinal displacement and the lateral displacement of the vehicle dependent upon the provided object data and lane data.
